(19) United States
(12) Patent Application Publication
(10) Pub. No.: US 2026/0149609 A1
(43) Pub. Date: May 28, 2026

(54) Device and Method for Simplified POE Port Matrix Configuration

(71) Applicant: Microchip Technology Inc., Chandler, AZ (US)

(72) Inventors: Alon Ferentz, Petach Tikva (IL); Avi Tkuma, Bat-Yam (IL); Nir Barniv, Herzliya (IL)

(73) Assignee: Microchip Technology Inc., Chandler, AZ (US)

(21) Appl. No.: 19/303,475

(22) Filed: Aug. 19, 2025

Related U.S. Application Data
(60) Provisional application No. 63/725,132, filed on Nov. 26, 2024.

(51) Int. Cl. H04L 12/10; H04L 12/40; H04L 41/0806

(52) U.S. Cl. CPC H04L 12/10; H04L 12/40045; H04L 41/0806

(57) ABSTRACT

A circuit is provided comprising a first configuration register including a partner port value and an indicator, a second configuration register including a partner port value and an indicator, a first ethernet port associated with the first configuration register, the first ethernet port providing power over ethernet (POE) using a POE configuration in a plurality of POE configurations based on the values of the first configuration register, a second ethernet port associated with the second configuration register, and a management bus connection to receive values to store in the first and second configuration registers.

### RELATED APPLICATIONS

This application claims the benefit of U.S. application 63/725,132, filed on Nov. 26, 2024, and incorporates that application by reference in its entirety.

### FIELD OF THE INVENTION

Configuration of power over ethernet (POE) devices.

### BACKGROUND

Ethernet is a networking technology that may use pairs of conductors that are twisted together to form transmission lines. One common implementation uses four pairs of conductors. Power over ethernet (POE) is a technology for piggybacking power over at least some of the twisted pair ethernet lines connecting a POE switch to a POE device. POE allows a single wired connection to a remote device that powers the device and provides network connectivity. For example, a remote camera might receive power over its ethernet connection and communicate with a video server over the same connection. POE power may be supplied by connecting transformers the ethernet transmission lines at a POE source (e.g., an ethernet switch) to inject alternating current power at kilohertz frequencies on to transmission lines with signals in the megahertz range. A POE device may have corresponding transformers to separate the power from the signal. Many POE devices include additional power supply circuitry to convert the alternating current source to direct current. One configuration of POE provides power from a POE port to a remote device over two of four twisted pairs in an ethernet cable. Another configuration of POE provides power over four of four twisted pairs. A 4P configuration can provide more power to the remote device. Software-based approaches to configuring a POE switch require true real-time scheduling to avoid misconfigurations that might damage circuitry in the POE switch or result in unwanted power delivery configurations to down-stream ethernet devices. Software-based approaches also involve complex mapping of port numbers that requires additional memory and processing to perform a configuration.

### SUMMARY

In some examples, a circuit is provided including a first configuration register including a partner port value and an indicator, a second configuration register including a partner port value and an indicator, a first ethernet port associated with the first configuration register, the first ethernet port providing power over ethernet (POE) using a POE configuration in a plurality of POE configurations based on the values of the first configuration register, a second ethernet port associated with the second configuration register, and a management bus connection to receive values to store in the first and second configuration registers. In certain examples, the circuit comprises control logic to, if the first configuration register partner port value identifies the first ethernet port, configure the first ethernet port in a 2P configuration. In certain examples, the circuit comprises control logic to, if the first configuration register partner port value identifies the second ethernet port and the first configuration register indicator is set to primary, configure the first ethernet port in a 4P configuration. In certain examples, the circuit comprises control logic to, if the first configuration register partner port value identifies the second ethernet port and the first configuration register indicator is set to primary, configure the first ethernet port in a 4P configuration. In certain examples, the circuit comprises control logic to, if the second configuration register partner port identifies a port other than the first ethernet port, write an error code to a status register. In certain examples, the first ethernet port and the second ethernet port are configured solely based on the values in the first configuration register and the second configuration register. In certain examples, the first ethernet port is configured solely based on the values in the first configuration register.

In some examples, a method is provided comprising receiving at a management bus interface to an integrated circuit a plurality of configuration values, each configuration value including a partner port value and an indicator, wherein each configuration value is associated with a corresponding power over ethernet (POE) port of the integrated circuit; receiving at the management bus interface a configuration command; in response to the configuration command, for each configuration value of the plurality of configuration values writing an error code to an error register of the integrated circuit if the configuration value is determined by the integrated circuit to be invalid; and configuring the POE port of the integrated circuit based on the configuration value if the configuration value is determined by the integrated circuit to be valid. In certain examples, if the partner port value of the configuration value identifies the POE port corresponding to the configuration value, configuring the corresponding POE port in a 2P configuration. In certain examples, if the partner port value of the configuration value identifies an adjacent POE port and the indicator is set to primary, configure the corresponding POE port in a 4P configuration. In certain examples, if the partner port value identifies an adjacent POE port and the indicator is set to secondary, configure the corresponding POE port to supply power to the adjacent POE port. In certain examples, the method includes determining by the integrated circuit that the identifier is set to secondary and the partner port of the configuration value identifies a port other than an immediately preceding POE port, write an error code to a status register. In certain examples, each POE port is configured solely based on the corresponding configuration value. In certain examples, the method comprises, after writing an error code to an error register of the integrated circuit, disabling all POE ports.

In some examples, a system is provided comprising a management system including a processor and a non-transitory computer readable memory with instructions that when executed on the processor cause the processor to load configuration values to of a POE switch; and the POE switch comprising the first configuration register to receive a partner port value and an indicator from the management system, the second configuration register including a partner port value and an indicator, a first ethernet port associated with the first configuration register, the first ethernet port providing power over ethernet (POE) in either a POE configuration in a plurality of POE configurations based on the values of the first configuration register, and a second ethernet port associated with the second configuration register. In certain examples, the POE switch comprises control logic to, if the first configuration register partner port value identifies the first ethernet port, configure the first ethernet port in a 2P configuration. In certain examples, the POE switch comprises control logic to, if the first configuration register partner port value identifies the second ethernet port and the first configuration register indicator is set to primary, configure the first ethernet port in a 4P configuration. In certain examples, the POE switch comprises control logic to, if the first configuration register partner port value identifies the second ethernet port and the first configuration register indicator is set to primary, configure the first ethernet port in a 4P configuration. In certain examples, the POE switch comprises control logic to, if the second configuration register partner port identifies a port other than the first ethernet port, write an error code to a status register. In certain examples, configuration of the first ethernet port and the second ethernet port is based solely on the configuration values communicated from the management system to the POE switch.

### BRIEF DESCRIPTION OF THE FIGURES

FIG. 1 illustrates a system for implementing matrix configuration of POE ports, according to certain examples.

FIG. 2 illustrates a broader system for implementing matrix configuration of POE ports, according to certain examples.

FIG. 3 illustrates a matrix conversion approach for configuring POE devices, according to certain examples.

FIG. 4 illustrates an example matrix configuration, according to certain examples.

FIG. 5 illustrates an example representation of port configuration values, according to certain examples.

FIG. 6 illustrates an example method for configuring a POE switch, according to certain examples.

### DETAILED DESCRIPTION

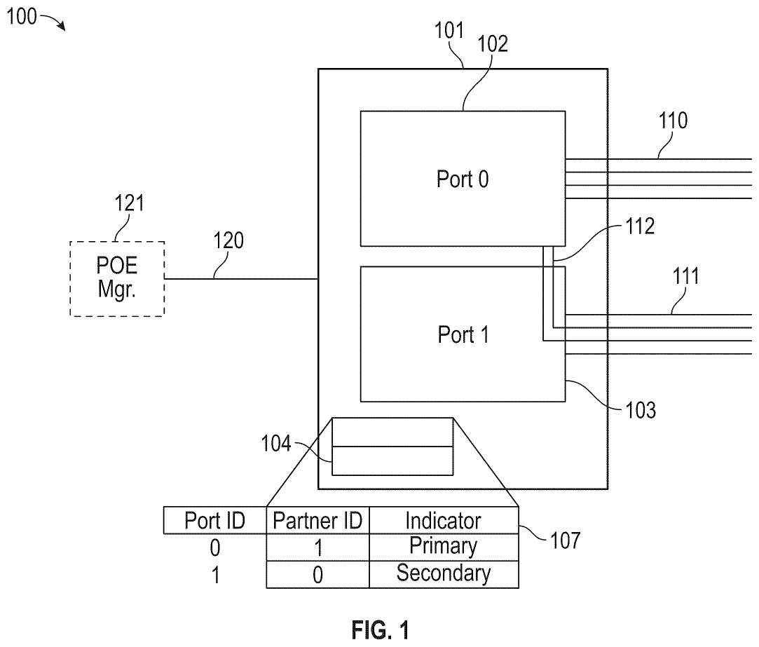

FIG. 1 illustrates a system for implementing matrix configuration of POE ports, according to certain examples. System 100 includes POE port module 101. POE port module may be a circuit that provides ethernet switching functionality with POE. In some examples, POE port module 101 may be an integrated circuit. In some examples, POE port module 101 may be a multi-chip module. POE port module 101 may be configured over I2C bus 120 (via a bus interface) by POE manager 121. I2C bus 120 is an example of a management bus, but other bus types may be used. POE manager 121 may be a software application running on a processor and coupled to the POE port module 101 via I2C bus 120. In some examples, POE manager 121 may be a non-realtime application executing on a non-realtime operating system. For example, POE manager 121 may be an application executing on a typical WINDOWS® workstation providing a network administrator with a visual display to configure POE ports and initiate signal to push that configuration to POE port module 101. POE manager 121 may then be closed or set aside. If the user wishes to check on the success of the configuration operation, the user can restart POE manager 121 (or switch back to the application if it was set aside) and POE manager 121 will query POE port module 101 for error information. POE manager 121 may not need to be immediately accessible to POE port module 101 for POE port module 101 to configure its physical ethernet ports. In some examples, POE manager 121 may be running on an embedded operating system such as EMBEDDED LINUX. In some examples, POE manager 121 may be running on a server such as a cloud server, a web server, or an application server. POE manager 121 may be accessible via a web interface to allow design of port configuration changes and to allow a user to execute configuration changes. In response to a page refresh, POE manager 121 may query POE port module 101 for error information.

POE port module 101 may include sequentially numbered physical ethernet ports, e.g., Port 0 (102) and Port 1 (103). Sequentially numbered ports may be laid out in silicon in numeric order such that adjacent ports are physically adjacent, e.g., Port 1 is adjacent to Port 0. POE port module 101 may also include matrix configuration registers 104, with one matrix entry for each of Port 0 (102) and Port 1 (103). Port 0 (102) may communicate with an ethernet device over four transmission line pairs 110. Port 0 (102) may provide power over two of the four transmission line pairs 110 in a 2P configuration. Port 1 (103) may communicate with another ethernet device over four transmission line pairs 111. Port 1 (103) may provide power over two of the four transmission line pairs 111 in a 2P configuration. In some configurations, Port 0 may supply power over lines 112 two of four transmission line pairs 111 to facilitate power distribution over all four transmission line pairs 111 in a 4P power distribution. In some examples, only adjacent ports may share power to simplify power distribution within POE port module 101. In some examples, only odd numbered ports may share power and may only share power with an immediately preceding port (e.g., Port 1 may only draw power from Port 0). Table 107 of FIG. 1 illustrates one approach to implementing matrix configuration registers 104. Table 107 includes two rows. The first row corresponds to Port 0 (102) and the second row corresponds to Port 1 (103). The first column of data contains the identifier of the partner port and the second column of data is the indicator (e.g., primary or secondary).

In some examples, POE port module 101 may include cight physical ports. In some examples, POE port module 101 may be replicated in a single enclosure to provide 16, 32, 48, or 64 ports. In some examples, a port (e.g., port 102 or port 103) in a 2P configuration may be further configured to select which two pairs carry power. In some examples, logic within POE port module 101 may disable POE power delivery to a physical ethernet port (e.g., Port 0 or Port 1) if a misconfiguration is detected for that physical ethernet port. In some examples, POE port module 101 may continue to provide network connectivity without POE power delivery. In some examples, transmission line pairs 111 and 112 are coupled via transformers to data lines that drive twisted pairs in an ethernet connection.

Matrix configuration registers 104 include an entry for each of ports 102 and 103. Each entry specifies a port ID, a partner ID, and an indication of whether the port is primary or secondary. If the port ID matches the partner ID, the port ID port may be configured as 2P and the port has no partner. If the port is 2P port and is marked secondary, the port may be configured as 2P midspan (e.g., the middle pairs are powered rather than the outer pairs). If the port ID differs from the partner ID and is marked primary, the port may be configured as a 4P port drawing additional power from the partner port. If the port ID differs from the partner ID and is marked secondary, the port may provide extra power to the partner port. In some examples, if the partner port is set to a predefined partner code (e.g., 15), the port may be disabled. In some examples, if the matrix configuration registers include two entries specifying the same partner port, the matrix configuration may cause a configuration error and all ports may be disabled until a valid configuration is provided. In some examples, specifying a partner port that does not have its own configuration may cause a configuration error. In some examples, a configuration matrix entry with a partner port number matching the primary port number may specify a 2P port. In these examples, if the port is identified as primary, the port may be configured as a 2P port with no backoff. In these examples, if the port is identified as secondary, the port may be configured as a 2P port with backoff for used in a midspan configuration. The backoff functionality may be used for a midspan configuration to allow a potentially present endpoint device to detect and power on a port. In some examples, when a port is identified as a partner port and secondary the port will support a 4P connection with no backoff. In some examples, POE port module 101 may include eight ports and matrix configuration registers 104 may include eight entries, each entry associated with one port and each entry specifying a partner id and an indicator of primary or secondary. In some examples, matrix configuration registers 104 may include a command register to receive a command from POE manager 121. For example, POE manager 121 may write, via I2C bus 120, configuration values to matrix configuration registers 104 for each port of POE port module 101 and then write a configuration command to the command register to initiate the configuration process. In some examples, matrix configuration registers 104 may be temporary registers and POE port module 101 may include logic to, responsive to the configuration command, copy the contents from the temporary registers to a set of active registers.

In some examples, the primary port may be responsible for the entire 4P port configuration, behavior, and total port power limit. For example, a 4P port may provide a voltage, for example, between 50 and 57 volts. In some examples, a 4P port may provide a selectable maximum power of 45, 60, 75, or 90 Watts. In some examples, a 4P port may negotiate a power output level with a connected device. In some examples, a 4P port may determine whether a power output level requested by a connected device is available based on the power output levels provided by other connected devices. In some examples, POE port module 101 may maintain a sum of the total power output of all active POE ports and a limit of available power. If a POE device attempts to negotiate more power than the difference between the limit and the current sum of total power output, POE port module 101 may disable the port and report an error condition.

In some examples, each physical port may monitor itself for errors, monitor its partner for errors, and may disconnect itself and/or its partner port, depending on configuration logic. In some examples, each pair set may report to a manager the reason for disconnect. In some examples, if a port determines the connected device requires higher power than POE port module 101 can provide in its current configuration, the port may disconnect and register an error condition. When POE manager 121 next polls the status of the port, the port may report the error condition. In some examples, Port 0 may identify an error condition if it is configured as a 2P port and if Port 1 is configured as a 4P port. In some examples, Port 0 may identify an error condition if it is configured as a secondary port and paired with Port 1 while Port 1 is configured with itself as a partner port. In some examples, POE port module 101 may include a status register that may be read by POE manager 121 via I2C bus 120. The status register may store information representing various status conditions. For example, one status code may indicate that POE port module 101 is unconfigured and idle. Another status code may indicate that POE port module 101 has been configured. Another status code may indicate a configuration error. Yet another status code may identify the lowest port number for which a configuration error was identified. Another status code may indicate an inability to supply the total power requested by all connected POE devices.

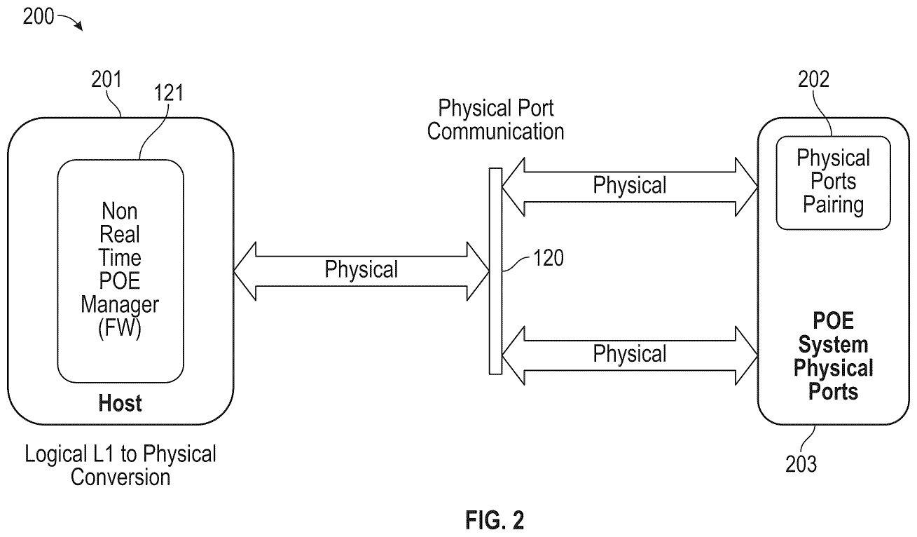

FIG. 2 illustrates a broader system for implementing matrix configuration of POE ports, according to certain examples. System 200 may include I2C bus 120 providing communication between host 201, which includes POE manager 121, and POE port module 203 including physical ports pairing logic 202. In some examples, POE manager 121 may operate as a conventional, non-real-time application. Because POE port module 203 operates autonomously, POE manager 121 may communicate with POE port module 203 to set up a new configuration. After that configuration process, POE manager 121 may query POE port module 203 to obtain the current status including any error messages. POE port module 203 may include eight physical ports in some examples. POE manager 121 may manage a plurality of POE port modules 203. In some examples, system 200 may be housed in a single enclosure to provide a managed ethernet switch. For example, system 200 may include one POE manager 121 along with four eight-port POE port module 203 to form a 32-port ethernet switch.

Disclosed examples may reduce or eliminate conversions of logical to physical ports within a POE device that may be required by existing designs. Disclosed examples may allow POE manager 121 to directly communicate with physical ports. Disclosed examples may allow error handling within POE port module 203 without real-time intervention by POE manager 121. Disclosed examples may allow local handling of errors between pair-sets within POE port module 203 without real-time intervention by POE manager 121. Disclosed examples may allow local handling of errors between pair-sets without any intervention by POE manager 121. Disclosed examples may allow a single mapping by POE manager 121 of logical ports to physical ports. Disclosed examples may reduce memory consumption at POE manager 121 and POE port module 203 because POE manager 121 may configure POE port module 203 once after initialization by configuring two registers for each physical port, e.g., partner port and primary pair set, without more than one layer of logical port translation. In some examples, POE manager 121 configures POE port module 203 once after initialization, thereby reducing configuration traffic on I2C bus 120. Disclosed examples may eliminate interrupt driving processing by POE manager 121 because errors may be handled locally within POE port module 203 allowing POE manager 121 to poll for status (including any error conditions) at a time convenient for POE manager 121.

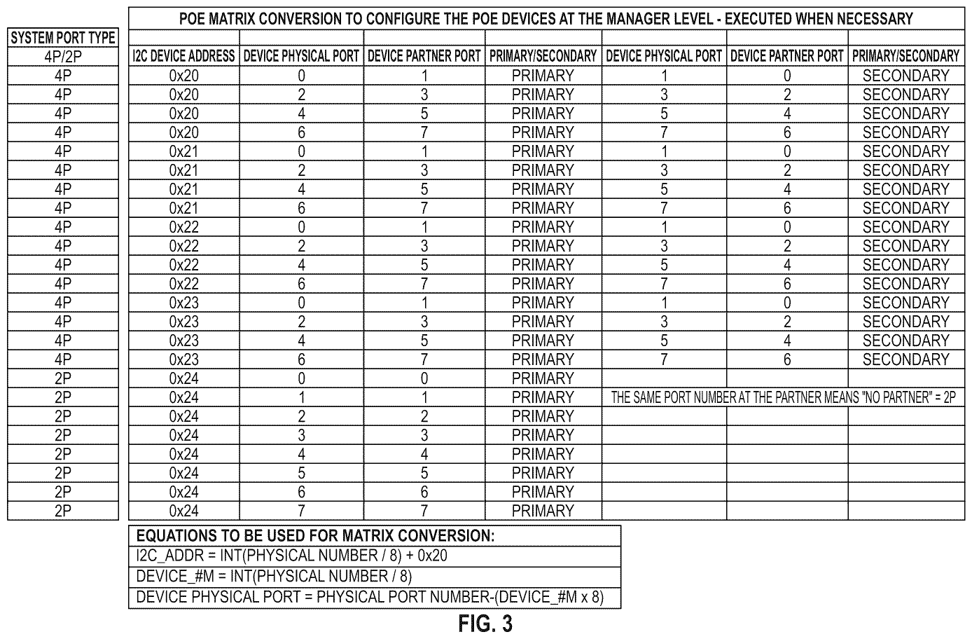

FIG. 3 illustrates a matrix conversion approach for configuring POE devices, according to certain examples. The table of FIG. 3 illustrates configuration settings of five POE port modules 101 as viewed from POE manager 121. The single column on the left provides a label to aid the reader of this application and need not be stored in the configuration matrix. The configuration matrix table includes a first column with the configuration bus address for each of the POE port modules 101. The second column is a physical port identifier. This may alternatively be represented as an index into the table. The third column is a device partner port identifier. If the device partner port is equal to the physical port identifier, the port is not paired with another port and may be configured as a 2P port. If the device partner port is set to a value other than the physical port identifier, the port may be paired with the port identified in the device partner port identifier. The fourth column is an indicator field set to “primary” or “secondary.” The fifth through seventh columns could be viewed as additional rows in columns two through four and show the configuration values for the ports configured as secondary in a 4P configuration. In this example, even numbered ports may be configured as primary 4P ports or secondary 2P ports while odd numbered ports may be configured as secondary to a 4P port or primary as a 2P port. In another example, odd numbered ports may be configured as primary 4P ports or secondary 2P ports. In some examples, restricting a partner port to be the adjacent port may simplify error identification logic. In some examples, the configuration matrix may be simplified further to represent the device partner port value to a Boolean with FALSE indicating no partner port, i.e., a 2P configuration, and a TRUE indicating a partner port, i.e., a 4P configuration.

In certain examples, each POE port modules 101 may include eight ports and each POE port module 101 may be addressable on the I2C bus with the first POE port module 101 addressed 0×20. The second may be addressed at 0×21 and so forth. In these examples, POE manager 121 may quickly convert a port number into a POE port module address and physical port number within that POE port module as follows. For example, port number 32 in a 48 port switch may map to a POE port module 101 with an I2C address of INT (32/8)+0×20. or 0×24. The device number for the POE port module 101 would be INT (32/8), or 4. And the device physical port number is (32-4×8), or zero. Thus port 32 maps to the zeroth port of the fourth POE port module 101 on the I2C bus. Likewise, port 33 maps to port 1 of the fourth POE port module 101.

In this example, POE port modules 101 with device addresses 0×20 through 0×23 are each configured with four ports providing 4P power, i.e., ports 0, 2, 4, and 6, while ports 1, 3, 5, and 7 are partnered with ports 0, 2, 4, and 6. In some examples, these odd numbered ports configured as secondary to 4P ports may be enabled as ethernet only without POE capability. Also in this example, POE port module 101 with device address 0×24 is configured with ports 0 through 7 as providing 2P power.

Table 1 shows an alternative view of the same configuration information of FIG. 3. Physical port numbers for a forty port POE switch are listed sequentially in the first column. For each switch port number, the additional columns indicate the device physical port, the device partner port specifier, and the indicator of primary or secondary. The first eight physical ports (numbered 0 through 7) map to the eight device ports of the first POE port module 101. The second eight physical ports (numbered 8 through 15) map to the eight device ports of the second POE port module 101. And so forth. In some examples, POE manager 121 may represent the physical port number as a row number of a table specifying the device partner port and the indicator as the device physical port may be calculated from the row number (physical port number) using the equations of FIG. 3.

TABLE 1

| | Device Physical | Device Partner | |
|---|---|---|---|
| Physical Port | Port | Port | Indicator |
| 0 | 0 | 1 | PRIMARY |
| 1 | 1 | 0 | SECONDARY |
| 2 | 2 | 3 | PRIMARY |
| 3 | 3 | 2 | SECONDARY |
| 4 | 4 | 5 | PRIMARY |
| 5 | 5 | 4 | SECONDARY |
| 6 | 6 | 7 | PRIMARY |
| 7 | 7 | 6 | SECONDARY |
| 8 | 0 | 1 | PRIMARY |
| 9 | 1 | 0 | SECONDARY |
| 10 | 2 | 3 | PRIMARY |

. . .

| | | | |
|---|---|---|---|
| 32 | 0 | 0 | PRIMARY |
| 33 | 1 | 1 | PRIMARY |
| 34 | 2 | 2 | PRIMARY |
| 35 | 3 | 3 | PRIMARY |
| 36 | 4 | 4 | PRIMARY |
| 37 | 5 | 5 | PRIMARY |
| 38 | 6 | 6 | PRIMARY |
| 39 | 7 | 7 | PRIMARY |

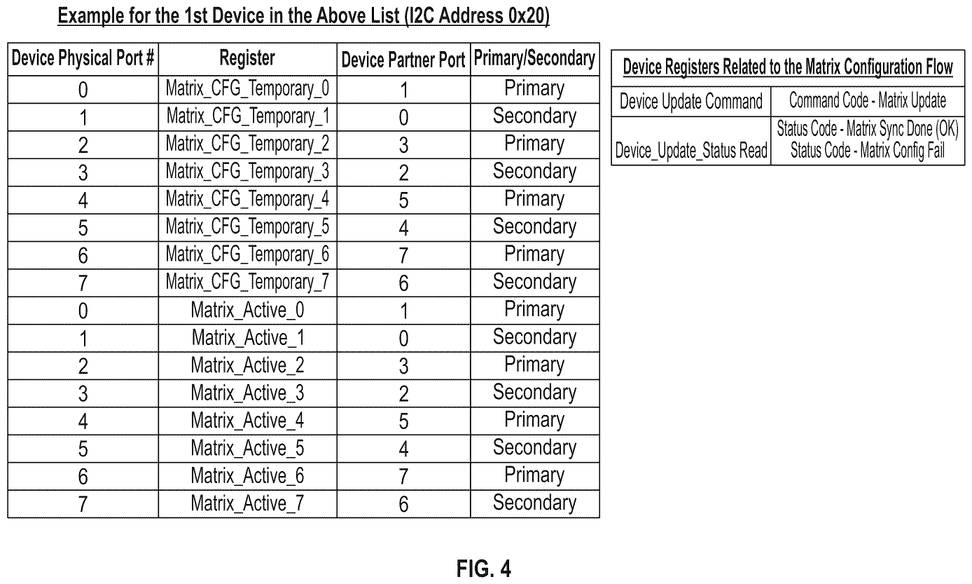

FIG. 4 illustrates an example matrix configuration of an individual POE port module, according to certain examples. In this example, the configuration register values are shown for the first POE port module of FIG. 3 and/or Table 1. Device physical port number may be represented as the row number of a configuration table. This figure illustrates two configuration registers, a temporary register and an active register, each register storing configuration values for each physical ports of the eight port POE port module. The temporary register may store new configuration values in advance of a configuration command. The active register may store active configuration values. In some examples, POE manager 121 may load the temporary register with new configuration values for ports 0 through 7 and the write a matrix update command code to the device update command register. Responsive to the matrix update command code, the POE port module will reset, copy the values from the temporary register to the active register, and initiate a configuration process. POE manager 121 may read the device status register to inquire into the device status. In some examples, the status register may report a successful matrix sync indicating successful configuration. In some examples, the status register may report a matrix configuration failure indicating a failure of the configuration process.

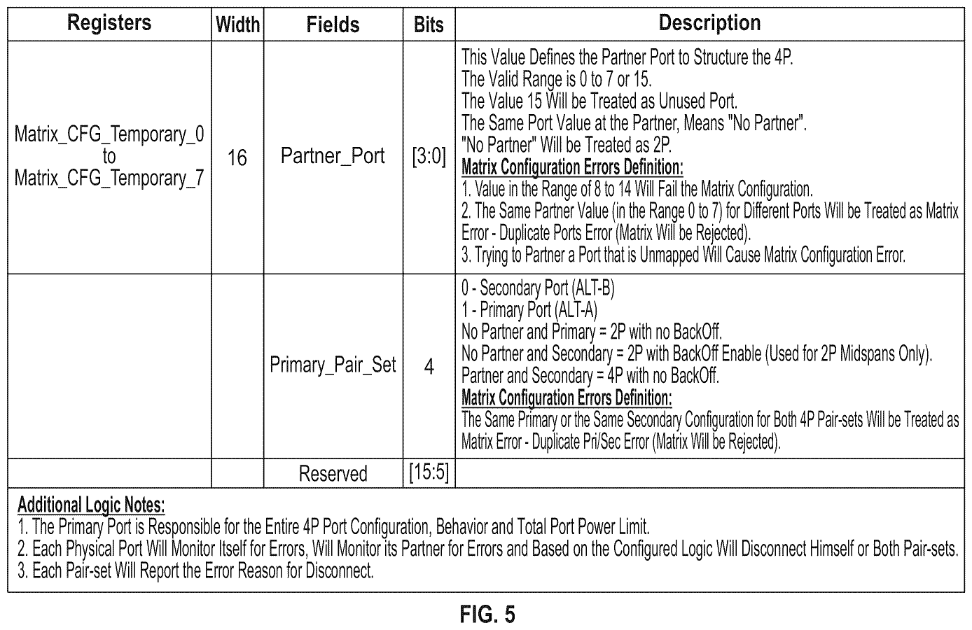

FIG. 5 illustrates an example representation of port configuration values, according to certain examples. Eight registers are provided, named Matrix_CFG_Temporary_0 through Matrix_CFG_Temporary_7 with the numeric value corresponding to a device physical port number. Each register may be 16 bits wide. The Partner_Port field of each register may be 4 bits, e.g., bits [3:0]. Valid values are 0 to 7 or 15. A value of 15 may disable the port. A value 0 to 7 represents a port number. If the Partner_Port value matches the device physical port number, the physical port has no partner and will be configured as a 2P port. If the Partner_Port value is different than the physical port number the physical port may be configured as a 4P port partnered with the port identified by Partner_Port. Certain conditions may be treated as an error. In some examples, if Partner_Port is in the range 8 to 14, the matrix configuration may fail. In some examples, if two physical ports on the same device have the same Partner_Port number, the matrix configuration may fail. In some examples, if Partner_Port identifies an unmapped port the matrix configuration may fail.

One bit, e.g., bit [4] of each register is the Primary_Pair_Set indicator. If a partner is identified for a port, the Primary_Pair_Set indicator indicates whether this port is primary or secondary in a 4P pair with no backoff. If no partner is identified for the port, Primary_Pair_Set indicating primary may designate the port as 2P with no backoff and Primary_Pair_Set indicating secondary may designate the port as 2P with backoff (which may be used for 2P midspans). If the same primary port or same secondary port for two different 4P pairings, the matrix configuration may fail.

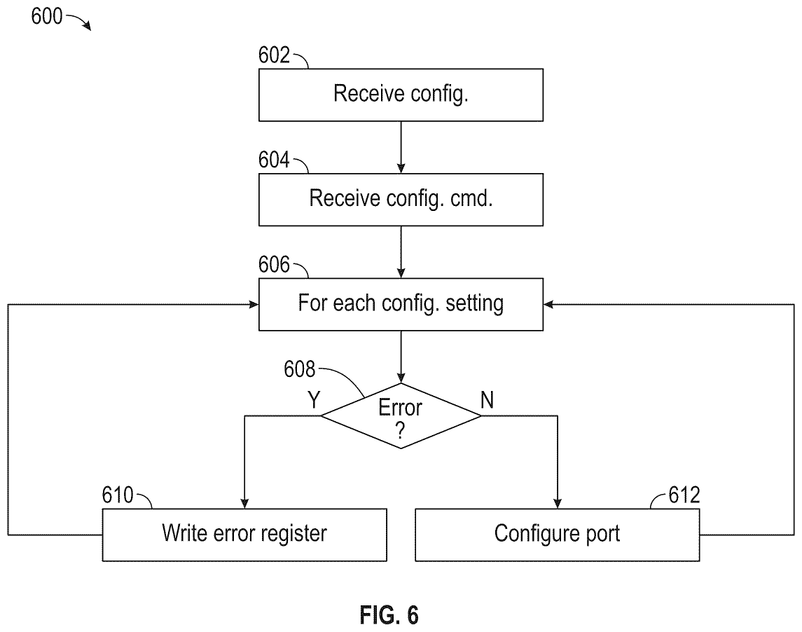

FIG. 6 illustrates a configuration process for a POE port module 101, according to certain examples. Method 600 begins at block 602. At block 602, POE port module 101 receives configuration information for two or more physical POE ports, the configuration information including a partner port value and an indicator for each physical POE port to configure. At block 604, POE port module 101 receives a configuration command and, responsive to that command, copies the configuration information into its configuration registers. At block 606, logic within POE port module 101 iterates over each physical POE port configuration entry in the configuration registers. In some examples, logic may evaluate all entries simultaneously to achieve the same result of iterating over each configuration entry. At block 608, logic within POE port module 101 inspects the POE port configuration entry for a specific port and determines whether an error exists in the entry. For example, if the physical POE port configuration for one port is designated as secondary to another port but that other port is configured as a 2P port, logic within POE port module 101 may flag an error in the inconsistent configuration. In another example, if POE ports are numbered sequentially from 0 to 7 and the physical POE port configuration for one port designates a partner port that is more than one port number greater or less than the one port, logic within POE port module 101 may flag an error if the hardware within POE port module 101 cannot route power between those two ports. In another example, if the physical POE port configuration configures one port as primary and a higher numbered port as a partner port, logic within POE port module 101 may flag an error if the hardware within POE port module 101 cannot route power from a higher numbered secondary port to a lower numbered primary port. At block 610, if an error has been flagged, logic within POE port module 101 may write an error code to an error register to be queried by a POE management application. The POE management application need not be a real-time application. In some examples, the error code may identify the first port number that could not be configured as the result of a configuration error. In some examples, the error code may identify all port numbers that could not be configured. In some examples, the error code may identify the type of configuration error. In some examples, logic within POE port module 101 may disable a single port if that port is the subject of an erroneous configuration. In some examples, logic within POE port module 101 may disable all ports in POE port module 101 if any configuration error is identified. In some examples, the presence of a configuration error terminates the method at block 610. In some examples, the method returns to block 606. At block 612, logic in POE port module 101 configures the physical POE port identified at block 606 and the method returns to block 606.

Although examples have been described above, other variations and examples may be made from this disclosure without departing from the spirit and scope of these examples.

We claim:

1. A circuit comprising:
a first configuration register including a partner port value and an indicator,
a second configuration register including a partner port value and an indicator,
a first ethernet port associated with the first configuration register, the first ethernet port to provide power over ethernet (POE) using a POE configuration in a plurality of POE configurations based on the contents of the first configuration register,
a second ethernet port associated with the second configuration register, and
a management bus connection to receive contents for the first and second configuration registers.

2. The circuit of claim 1, comprising control logic to:
if the first configuration register partner port value identifies the first ethernet port, configure the first ethernet port in a 2P configuration.

3. The circuit of claim 1, comprising control logic to:
if the first configuration register partner port value identifies the second ethernet port and the first configuration register indicator is set to primary, configure the first ethernet port in a 4P configuration.

4. The circuit of claim 1, comprising control logic to:
if the first configuration register partner port value identifies the second ethernet port and the first configuration register indicator is set to primary, configure the first ethernet port in a 4P configuration.

5. The circuit of claim 4, comprising control logic to:
if the second configuration register partner port identifies a port other than the first ethernet port, write an error code to a status register.

6. The circuit of claim 1, wherein the first ethernet port and the second ethernet port are configured solely based on the values in the first configuration register and the second configuration register.

7. The circuit of claim 1, wherein the first ethernet port is configured solely based on the values in the first configuration register.

8. A method comprising:
receiving at a management bus interface to an integrated circuit:
a plurality of configuration values, each configuration value including a partner port value and an indicator,
wherein each configuration value is associated with a corresponding power over ethernet (POE) port of the integrated circuit;
receiving at the management bus interface a configuration command;
in response to the configuration command, for each configuration value of the plurality of configuration values:
writing an error code to an error register of the integrated circuit if the configuration value is determined by the integrated circuit to be invalid; and
configuring the POE port of the integrated circuit based on the configuration value if the configuration value is determined by the integrated circuit to be valid.

9. The method of claim 8, wherein configuring the POE port of the integrated circuit based on the configuration value comprises:
if the partner port value of the configuration value identifies the POE port corresponding to the configuration value, configure the corresponding POE port in a 2P configuration.

10. The method of claim 8, wherein configuring the POE port of the integrated circuit based on the configuration value comprises:
if the partner port value of the configuration value identifies an adjacent POE port and the indicator is set to primary, configure the corresponding POE port in a 4P configuration.

11. The method of claim 8, wherein configuring the POE port of the integrated circuit based on the configuration value comprises:
if the partner port value identifies an adjacent POE port and the indicator is set to secondary, configure the corresponding POE port to supply power to the adjacent POE port.

12. The method of claim 11, comprising:
determining by the integrated circuit that the identifier is set to secondary and the partner port of the configuration value identifies a port other than an immediately preceding POE port, write an error code to a status register.

13. The method of claim 8, wherein each POE port is configured solely based on the corresponding configuration value.

14. The method of claim 8, comprising:
after writing an error code to an error register of the integrated circuit, disabling all POE ports.

15. A system comprising:
a management system including a processor and a non-transitory computer readable memory with instructions that when executed on the processor cause the processor to load configuration values to of a POE switch; and
the POE switch comprising:
the first configuration register to receive a partner port value and an indicator from the management system,
the second configuration register including a partner port value and an indicator,
a first ethernet port associated with the first configuration register, the first ethernet port providing power over ethernet (POE) in either a POE configuration in a plurality of POE configurations based on the values of the first configuration register, and
a second ethernet port associated with the second configuration register.

16. The system of claim 15, the POE switch comprising control logic to:
if the first configuration register partner port value identifies the first ethernet port, configure the first ethernet port in a 2P configuration.

17. The system of claim 15, the POE switch comprising control logic to:
if the first configuration register partner port value identifies the second ethernet port and the first configuration register indicator is set to primary, configure the first ethernet port in a 4P configuration.

18. The system of claim 15, the POE switch comprising control logic to:
if the first configuration register partner port value identifies the second ethernet port and the first configuration register indicator is set to primary, configure the first ethernet port in a 4P configuration.

19. The system of claim 15, the POE switch comprising control logic to:
if the second configuration register partner port identifies a port other than the first ethernet port, write an error code to a status register.

20. The system of claim 15, wherein configuration of the first ethernet port and the second ethernet port is based solely on the configuration values communicated from the management system to the POE switch.
